(19) United States
(12) Patent Application Publication
(10) Pub. No.: US 2005/0048166 A1
(43) Pub. Date: Mar. 3, 2005

(54) Compositions and methods for tenderizing meat

(75) Inventors: Isaac Ashie, Raleigh, NC (US); Thomas Sorensen, Raleigh, NC (US); Per Munk Nielsen, Hillerod (DK)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Novozymes North America, Inc., Franklinton, NC (US)

(21) Appl. No.: 10/883,074

(22) Filed: Jul. 1, 2004

Related U.S. Application Data
(60) Provisional application No. 60/484,005, filed on Jul. 1, 2003.

(51) Int. Cl. A23L 1/31

(52) U.S. Cl. 426/56

(57) ABSTRACT

The present invention relates compositions and methods for meat tenderization by contacting meat with a protease that has higher activity on the meat proteins troponin and myosin as compared to the meat proteins actin and collagen. The present invention also relates to screening methods for identifying enzymes suitable for use in tenderizing meat.

### CROSS-REFERENCE TO RELATED APPLICATIONS

This application claims the benefit under 35 U.S.C. 119 U.S. provisional application No. 60/484,005, filed Jul. 1, 2003, the contents of which are fully incorporated herein by reference

### FIELD OF THE INVENTION

The present invention relates to screening methods for identifying enzymes suitable for use in tenderizing meat. The present invention also relates compositions and methods for meat tenderization.

### BACKGROUND OF THE INVENTION

Tenderness is a major quality attribute that affects market price and consumer acceptance of meat products. There are several methods for improving meat tenderness, including mechanical tenderization, elevated temperature storage, calcium chloride injection, electrical stimulation, muscle stretching, shock-wave pressure, dry and wet aging, and enzymatic treatment.

One of the most widely used methods is treatment with an enzyme, such as, e.g., papain, bromelain, or ficin. These enzymes, however, have very broad specificities and therefore hydrolyze indiscriminately the major meat proteins (connective tissue/collagen and myofibrillar proteins) resulting in an over-tenderized (i.e., mushy) product. Furthermore, papain, which is the most widely used, is relatively heat-stable, allowing uncontrolled texture deterioration during and after cooking.

WO 01/06875 addresses the problems of the prior art enzymatic methods by contacting the meat with a tendering-effective amount of a thermolabile protease which has limited substrate specificity so that it (a) digest protein to a limited extent and/or (b) digests only one of the two major protein components of meat.

U.S. Pat. No. 5,972,683 discloses a subtilisn YaB mutant which is obtained by the substitution of the glycine residue at the 124, 151 and 159 positions of wild-type subtilisn YAB. The subtilisin YaB mutant is reported to have a relatively higher elastin/casein hydrolyzing activity, and is stated to be useful in meat tenderization.

There is a need in the art for improved meat tenderization methods and compositions and for improved screening methods for identifying improved meat tenderization methods and compositions.

### SUMMARY OF THE INVENTION

One aspect of the present invention provides a method for selecting a protease suitable for use in tenderizing meat by screening a protease or a library of proteases for a protease that has higher activity on the meat proteins troponin and/or myosin as compared to the meat proteins actin and/or collagen. Preferably, the present invention provides a method for selecting a protease suitable for use in tenderizing meat by screening a protease or a library of proteases for a protease which hydrolyzes the meat proteins troponin and/or myosin, but does not hydrolyze the meat proteins actin and/or collagen, and more preferably, the present invention provides a method for selecting a protease suitable for use in tenderizing meat by screening a protease or a library of proteases for a protease which hydrolyzes the meat proteins troponin and myosin, but does not hydrolyze the meat proteins actin and collagen.

In a preferred embodiment, the screening method comprises:
(a) contacting meat proteins and/or a subset of amino acids of the meat proteins with a protease or a library or proteases, and
(b) selecting one or more proteases which have higher activity on the meat proteins troponin and/or myosin as compared to the meat proteins actin and/or collagen, more preferably by, selecting one or more proteases which have higher activity on the meat proteins troponin and myosin as compared to the meat proteins actin and collagen.

In a more preferred embodiment, the screening method comprises:
(a) contacting meat proteins and/or a subset of amino acids of the meat proteins with a protease or a library or proteases, and
(b) selecting one or more proteases which hydrolyze the meat proteins troponin and/or myosin, but do not hydrolyze the meat proteins actin and/or collagen, and more preferably, selecting one or more proteases which hydrolyze the meat proteins troponin and myosin, but do not hydrolyze the meat proteins actin and collagen.

Another aspect of the present invention provides methods for tenderizing meat by contacting meat with a protease that has higher activity on the meat proteins troponin and/or myosin as compared to the meat proteins actin and/or collagen. Preferably, the present invention provides methods for tenderizing meat by contacting the meat with a protease that hydrolyzes the meat proteins troponin and/or myosin, but does not hydrolyze the meat proteins actin and/or collagen, and more preferably, contacting the meat with a protease that hydrolyzes the meat proteins troponin and myosin, but does not hydrolyze the meat proteins actin and collagen.

Another aspect of the invention provides tenderized meat products produced using the methods for tenderizing meat described herein.

Another aspect of the invention provides meat tenderizing compositions comprising a protease that has higher activity on the meat proteins troponin and/or myosin as compared to the meat proteins actin and/or collagen. Preferably, the meat tenderizing compositions comprise a protease that hydrolyzes the meat proteins troponin and/or myosin, but does not hydrolyze the meat proteins actin and/or collagen. More preferably, the meat tenderizing composition comprises a protease that hydrolyzes the meat proteins troponin and myosin, but does not hydrolyze the meat proteins actin and collagen.

### BRIEF DESCRIPTION OF THE FIGURES

FIG. 1 is a graph showing the dose-response of R. miehei protease as compared to papain on Top Rounds.

FIG. 2 is a graph showing the dose-response of R. miehie protease as compared to papain on Briskets.

### DETAILED DESCRIPTION OF THE INVENTION

As used herein, “meat” encompasses, without limitation, meat muscle, e.g., from beef, poultry or pork, whether present in a live animal or carcass or in fresh meat obtained from butchering, as well as frozen meat, freeze-dried meat, and restructured meat in any form.

As used herein “meat proteins” encompasses the two major meat proteins collagen and myofibrillar proteins. The “myofibrillar proteins” include the meat proteins actin, myosin and troponin.

As used herein “a subset of amino acids of a meat protein” refers to a subset of amino acids of a meat protein, e.g., a protein fragment of the meat protein, which the protease has enzymatic activity towards. In this regard, a subset of amino acids of a meat protein can be used instead of the entire meat protein to asses the activity of the enzyme toward the meat protein, when selecting a protease having the desired activity, as described herein.

As used herein, “tenderizing” or “tenderization” refers to a process by which the texture of meat is rendered more chewable or otherwise more acceptable to the consumer. Tenderization is typically assessed by measuring the relative shear force of the meat or by sensory evaluation. Relative shear force may be measured using the Warner-Bratzler method (Olson et al., J. Food Sci. 42:506, 1977; and Fogle et al., J. Food Sci. 47:1113, 1982). In this method, meat samples are carved into cylindrical shapes 0.75 cm in diameter with the axis of the cylinder along the longitudinal sections of the meat fibers. The samples are placed on a V-shaped Warner-Bratzler blade moving down at a steady speed of 2 mm/sec through a fixed distance (30-50 mm) slicing along the length of the sample. The maximum force required to slice through each sample is an indication of the shear force.

The protease(s) used in the present tenderizing methods and compositions has higher activity (protease degradation) on the meat proteins troponin and/or myosin, preferably troponin and myosin, as compared to the meat proteins actin and/or collagen, preferably actin and collagen. Conversely, the protease(s) used in the present tenderizing methods and compositions has lower activity (protease degradation) on the meat proteins actin and/or collagen, preferably actin and collagen, as compared to the meat proteins troponin and/or myosin, preferably troponin and myosin. As used herein, “higher activity” means that under identical processing conditions, the protease breaks down more peptide bonds, and “lower activity” means that under identical processing conditions, the protease breaks down fewer peptide bonds. A protease that has lower activity can also include a protease that does not have any detectable activity (protease degradation).

More preferably, the present invention provides methods for tenderizing meat by contacting the meat with a protease that hydrolyzes the meat proteins troponin and/or myosin, but does not hydrolyze the meat proteins actin and/or collagen. As used herein, the phrase “does not hydrolyze” means that no detectable hydrolysis was identified after incubating the meat protein or a subset of amino acids of the meat protein with the protease for a period of 30 min to several hours, e.g., 1, 2, 3 or 4 hours, and analyzing the incubation products by SDS-gel electrophoresis as described in Example 1. Relative activity of the protease on myofibrillar proteins and collagen was also evaluated spectrophotometrically, e.g., as outlined in Example 2.

The proteases may comprise wild-type or mutant enzymes. The protease may be isolated from their cell of origin or may be recombinantly produced using conventional methods well-known in the art. In a preferred embodiment, the protease is derived from a Rhizomucor species, including, without limitation, Rhizomucor miehei or Rhizomucor pusillus, more preferably R. miehei.

The protease preferably is also thermolabile protease. As used herein, a thermolabile protease is a protease that is inactiviated when the meat is cooked. More preferably, a thermolabile protease is a protease that is inactivated at temperatures of 55° C. to 70° C., more preferably 55° C. to 65° C. Thermolability, however, is not required to obtain the desired meat tenderization when using a protease that hydrolyzes the meat proteins troponin and/or myosin, but does not hydrolyze the meat proteins actin and/or collagen. Accordingly, in other embodiments, the protease may not be a thermolabile protease, as defined herein, that is, the protease is not inactivated at temperatures of 55° C. and 70° C., more preferably, 55° C. to 65° C.

In another preferred embodiment, the protease is not active or has substantially reduced activity during cold storage, e.g., during refrigeration or during frozen storage.

The methods for tenderizing meat involve contacting meat with a tenderizing-effective amount of a protease. In a preferred embodiment, the meat is tenderized by contacting the meat with the protease at a ratio (by weight) of between about 0.001 and about 0.1 Anson Units (AU)/100 g meat, preferably between about 0.0025 and about 0.05 AU/100 g meat, and most preferably between about 0.005 and about 0.05 AU/100 g meat. One AU is defined as the amount of enzyme which digests denatured hemoglobin at 25° C., pH 7.5 in 10 min, at an initial rate that liberates an amount of trichloroacetic acid-soluble material that is equivalent to one milliequivalent of tyrosine, when measured by color production using a phenol reagent.

In another preferred embodiment, tenderizing-effective amount of a protease is an amount of protease that results in a reduction of relative shear force to between about 50-90%, preferably between about 60-80% of the relative shear force exhibited by untreated meat.

The contacting step may involve any suitable enzymatic meat tenderization process. Preferably, the contacting step comprises one or more of (a) injecting the meat directly; (b) marinating the meat; or (c) injecting a live animal prior to slaughter. It will be understood that the time during which the meat is contacted with the protease, as well as the temperature at which the meat is contacted, will depend upon the mode (or combination of modes) that is (are) employed. For example, meat may be injected with a protease-containing solution and stored for up to about two weeks at 5° C. Alternatively, meat may be marinated for about 0.5-10 h at 5-10° C. The meat may also be contacted with the protease during cooking. The method may further comprise tumbling the meat in, e.g., the marinating solution, such as, e.g., for 1-3 h at 5-10° C.

It will be understood that each of the reaction conditions (such as, e.g., concentration of protease, ratio of protease:meat, mode of contacting, pH, temperature, and time) may be varied, depending upon the source of meat and/or enzyme and the degree of tenderization that is required. It will further be understood that optimization of the reaction conditions may be achieved using routine experimentation by establishing a matrix of conditions and testing different points in the matrix. The protease may be applied in any suitable form, such as, in liquid or powder form, as are well known in the art. Preferable, the protease is in liquid (aqueous) form, comprising additional flavor enhancing agents and formulation agents, such as, carbohydrates (such as, sugars); ash; acetic acid; sodium acetate; methionine, potassium sorbate.

The present invention also encompasses meat and meat products that have been tenderized using the above-described methods and compositions. Such meat and meat products include, for example, lamb, beef, pork, poultry and fish.

In other embodiments, the invention encompasses compositions for meat tenderization that comprise, in addition to the protease, one or more of brine, curing agents, and flavoring agents. Brine comprises, without limitation, sodium chloride, phosphates, dextrose, and other ingredients. Curing agents include, without limitation, nitrites, sugars, and erythorbate. Flavoring agents include, without limitation, herbs, spices, and liquid smoke.

One aspect of the present invention provides a method for selecting a protease suitable for use in tenderizing meat by screening a protease or a library of proteases for a protease that has higher activity on the meat proteins troponin and/or myosin as compared to the meat proteins actin and/or collagen.

More preferably, the present invention provides a method for selecting a protease suitable for use in tenderizing meat by screening a protease or a library of proteases for a protease which hydrolyzes the meat proteins troponin and/or myosin, but does not hydrolyze the meat proteins actin and/or collagen.

In preferred embodiment, the screening method comprises:
(a) contacting meat proteins and/or a subset of amino acids of the meat proteins with a protease or a library or proteases, and
(b) selecting one or more proteases which have higher activity on the meat proteins troponin and/or myosin as compared to the meat proteins actin and/or collagen, more preferably, selecting one or more proteases which have higher activity on the meat proteins troponin and myosin as compared to the meat proteins actin and collagen.

In another preferred embodiment, the screening method comprises:
(a) contacting meat proteins and/or a subset of amino acids of the meat proteins with a protease or a library or proteases, and
(b) selecting one or more proteases which hydrolyze the meat proteins troponin and/or myosin, but do not hydrolyze the meat proteins actin and/or collagen.

In an even more preferred embodiment, the screening method comprises:
(a) contacting meat proteins and/or a subset of amino acids of the meat proteins with a protease or a library or proteases, and
(b) selecting one or more proteases which hydrolyze the meat proteins troponin and myosin, but do not hydrolyze the meat proteins actin and collagen.

The screening methods may involve contacting all of the meat proteins at once or in various combinations (e.g., various combination of the myofibrillar proteins) or contacting the meat proteins individually. As would be apparent to the skilled artisan once apprised of the present invention, it may not be necessary to contact all of the meat proteins to select an appropriate protease with the desired activity. For example, if it is known that a protease does not have activity on collagen or has very low activity on collagen, it may not be necessary to screen the protease for activity on collagen. The activity on the meat proteins can be determined using standard procedures known in the art, such as, spectrophotometric and/or electrophoretic analysis.

As used herein, a library of proteases may be obtained in any manner, and can include, e.g., a library or protease variants, obtained by shuffling or other recombination methods, as are well-known in the art.

As used herein, “selecting one or more proteases” preferably includes the steps of identifying and isolating the protease or nucleic acid encoding the protease.

In another preferred embodiment, a method of screening for a protease having the desired meat tenderization activity, comprises:
(a) contacting meat proteins and/or a subset of amino acids of the meat proteins with a protease or a library or proteases, and
(b) selecting one or more protease which hydrolyze the meat proteins troponin and/or myosin, but do not hydrolyze the meat proteins actin and/or collagen; and
(c) producing the selected protease.

The method may further comprise screening the protease for thermolability as well as for activity during cold storage in a refrigerator or in a freezer.

### EXAMPLES

### Example 1

### Activity on Individual Myofibrillar Proteins

The following experiment was performed to determine the activity of the R. miehei protease on the myofibrillar proteins. The experiment was performed by separately incubating the myofibrillar proteins troponin, myosin and actin for a period of 4 hrs with the protease at 37° C. At the end of the period, an aliquot of each sample was transferred into a Tris-glycine SDS sample buffer (Invitrogen Life Technologies) and heated at 85° C. for 5 min. Samples were then loaded onto precast gels for electrophoresis and the hydrolytic activity of the protease was evaluated by analyzing the protein bands.

As shown in Table 1 below, the protease hydrolyzed both troponin and myosin, however, no hydrolysis was observed on actin.

TABLE 1

| Protein | Protease | Hydrolysis |
|---|---|---|
| Troponin | + | Yes |
| Troponin | − | No |
| Myosin | + | Yes |
| Myosin | − | No |
| Actin | + | No |
| Actin | − | No |

### Example 2

### Measurement of Relative Hydrolytic Potential of a Protease for Collagen and Myofibrils

The following experiments was performed to evaluate the relative activity of papain and the R. miehei protease on each of the two major protein components of meat.

Collagenase Activity:

1. To 20 mg collagen from bovine tendon (Sigma) suspended in 3.8 ml Tris buffer (0.02 M Tris, 0.005 M CaCl₂, pH 7.4) is added 200 μl collagenase (or protease) solution (1 mg/ml in Tris buffer) to make a total volume of 4.0 ml.
2. The mixture is incubated at 40° C. for 3 hr or 70° C. for 30 min.
3. The reaction mixtures are centrifuged in a microfuge for 10 min at 14,000 rpm.
4. 1.5 ml of supernatant is mixed with 4.5 ml of 5 N HCl and kept in a drying oven at 110° C. for 16 hrs (overnight) for complete hydrolysis of soluble peptides.
5. The hydrolysate is then analyzed for hydroxyproline content as follows:
   Hydroxyproline Content:
1. The hydrolysate is diluted 25 times with distilled water.
2. To 1.00 ml of diluted hydrolysate is added 1.00 ml of chloramine-T solution and the mixture is allowed to stand at room temperature for 20 min.
3. 1.00 ml of color reagent is added after this period and the reaction mixture is transferred to a 60° C. water bath and incubated for 15 min.
4. Tubes are removed and allowed to cool down to room temperature and absorbance measured at 560 nm.
   Myofibril Extraction: (Olson et al., 1976, J. Food Sci. 41: 1036-1041).
1. 100 g of minced meat is homogenized for 30 sec in 10 vols (v/w) KCl-phosphate buffer (100 mM KCl, 20 mM potassium phosphate—pH 7.0) at 11,000 rpm.
2. The homogenate is centrifuged at 1,000 g for 15 min and the pellet re-suspended in 5 vols (v/w) buffer and re-centrifuged under the same conditions.
3. The pellet is again re-suspended in 5 vols buffer and poured through strainer to remove connective tissue and debris.
4. The myofibril suspension obtained is centrifuged at 1,000 g for 15 min, re-suspended, and washed twice more with buffer.
5. The myofibril extract is suspended in buffer and protein content estimated using the Leco protein analyzer.
   Soluble Protein Analysis:
1. To 2.9-3.0 ml myofibril extract ia added 0-100 μl enzyme solution (1 mg protein/ml) and the reaction mixtures incubated at 70° C. for 30 min.
2. The reaction is stopped by adding 1.5 ml of 15% trichloroacetic acid and allowing the mixtures to stand at room temperature for 15 min.
3. The suspension is centrifuged at 10,000 rpm for 8 min and the absorbance of the supernatant at 280 nm is measured. 7
1. Alternatively, 1. 50 μl enzyme (1 mg protein/ml) is added to 1.95 ml of myofibril extract and incubated at 70° C. for 30 min.
2. The reaction is stopped by adding 2 ml of 15% trichloroacetic acid and allowing the mixture to stand at room temperature for 15 min.
3. The suspension is centrifuged at 10,000 rpm for 8 min and the absorbance of supernatant at 280 nm is measured.

The activity of papain as compared to R. miehei protease on collagen is shown in the Table 2 below.

TABLE 2

| Enzyme | Hydroxyproline (ppm) |
|---|---|
| Papain | 10.5 |
| R. miehei protease | 0 |

The activity of papain as compared to R. miehei protease on the myofibrillar proteins is shown in the Table 3 below.

TABLE 3

| Enzyme | Absorbance (280 nm) |
|---|---|
| Papain | 1.5 |
| R. miehei protease | 0.17 |

### Example 3

### Meat Tenderization

Post-rigor beef (top rounds and briskets) were injected with varying concentrations of R. miehei protease and papain, and cooked to internal temperatures of 55° C., 65° C., and 75° C. (131° F., 149° F., and 167° F.). These temperatures correspond to “rare”, “medium” and “well done”, respectively.

Tenderness of meat treated was objectively measured using a Warner-Bratzler shear test. The Warner-Bratzler shear involves a 1 mm thick steel blade with a triangular hole cut from it. Downward movement of the blade (at a speed of 2 mm/s through a fixed distance of 30 mm) pushes the cored test sample into the V-shaped notch of the triangular hole and the maximum force required to cut through the sample gives an indication of sample (meat) toughness. Tenderness is inversely related to the maximum shear force.

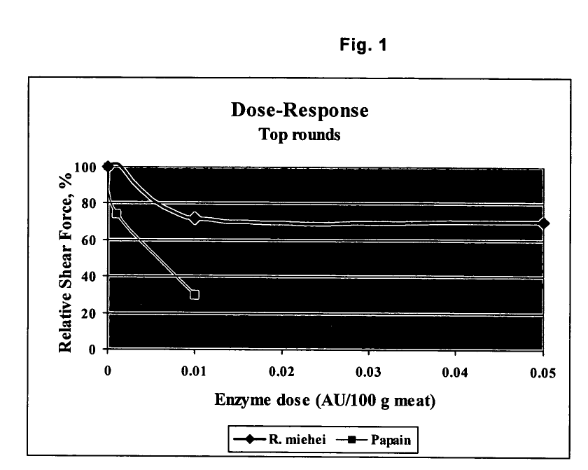

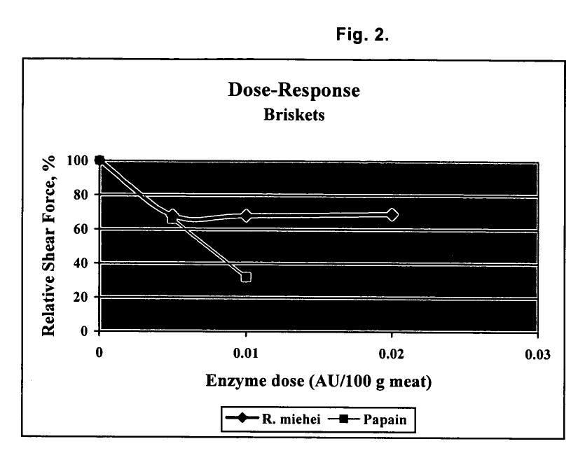

As shown in FIGS. 1 and 2, both R. miehei protease and papain broke down the meat tissue resulting in increased tenderness (i.e., reduction of relative shear force) of the meat. R. miehei protease showed self-limiting hydrolysis of meat tissue with no further tenderization at higher concentrations of the enzyme. On the other hand, concentration of papain had significantly greater influence on meat hydrolysis. As papain concentration increased, the propensity for over-tenderization and concomitant mushiness increased due to the indiscriminate breakdown of major meat proteins by papain.

1. A method for selecting a protease useful for tenderizing meat, comprising:
(a) contacting meat proteins and/or a subset of amino acids of the meat proteins with a protease or a library or proteases, and
(b) selecting one or more protease which has higher activity on the meat proteins troponin and myosin as compared to the meat proteins actin and collagen.

2. The method of claim 1, wherein said (b) comprises selecting one or more protease which hydrolyze the meat proteins troponin and/or myosin, but do not hydrolyze the meat proteins actin and/or collagen

3. The method of claim 1, wherein said (b) comprises selecting one or more protease which hydrolyze the meat proteins troponin and myosin, but do not hydrolyze the meat proteins actin and collagen.

4. The method of claim 1, wherein said (a) comprises contacting the meat proteins troponin, myosin, actin and collagen.

5. The method of claim 1, wherein said (a) comprises contacting the meat proteins and/or a subset of amino acids of the meat proteins with a library of proteases.

6. The method of claim 1, wherein said (a) comprises contacting the meat proteins and/or a subset of amino acids of the meat proteins with a library of protease variants.

7. A method for tenderizing meat, comprising contacting meat with a protease that has higher activity on the meat proteins troponin and myosin as compared to the meat proteins actin and collagen.

8. A method for tenderizing meat, comprising contacting meat with a protease that hydrolyzes the meat proteins troponin and/or myosin, but does not hydrolyze the meat proteins actin and/or collagen.

9. The method of claim 9, comprising contacting meat with a protease that hydrolyzes the meat proteins troponin and myosin, but does not hydrolyze the meat proteins actin and collagen.

10. The method of anyone of claim 7-9 wherein the protease is thermolabile.

11. The method of anyone of claims 7-9 wherein the protease is not thermolabile.

12. A tenderized meat products produced using the methods claims 7-11,

13. A meat tenderizing compositions comprising a protease that has higher activity on the meat proteins troponin and myosin as compared to the meat proteins actin and collagen.

14. A meat tenderizing compositions comprising a protease that has higher activity on the meat proteins troponin and/or myosin, but does not hydrolyze the meat proteins actin and/or collagen.

15. The meat tenderizing compositions of claim 14, wherein the protease has higher activity on the meat proteins troponin and myosin, but does not hydrolyze the meat proteins actin and collagen
